(19) United States
(12) Patent Application Publication
(10) Pub. No.: US 2025/0035514 A1
(43) Pub. Date: Jan. 30, 2025

(54) DEVICE FOR PREDICTING THE REMAINING LIFE OF A BEARING AND ASSOCIATED BEARING DEVICE AND METHOD

(71) Applicant: Aktiebolaget SKF, Göteborg (SE)

(72) Inventors: Sebastian ECHEVERRI RESTREPO, Utrecht (NL); Cornelis Harm TAAL, Utrecht (NL); Sebastien BLACHERE, Den Haag (NL)

(21) Appl. No.: 18/775,093

(22) Filed: Jul. 17, 2024

(30) Foreign Application Priority Data
Jul. 27, 2023 (DE) 102023207190.8

(51) Int. Cl. G01M 13/045; G05B 23/02

(52) U.S. Cl. CPC G01M 13/045; G05B 23/024; G05B 23/0283

(57) ABSTRACT

A device (9) for predicting the remaining life of a bearing is proposed. The device (9) includes a memory (10) and an implementing means (12). The memory (10) stores a neural network (11) to determine a remaining life of the bearing from measured vibrations of the bearing. The implementing means (12) implements the neural network (11).

### CROSS-REFERENCE TO RELATED APPLICATION

This application claims priority to German Application No. 102023207190.8, filed Jul. 27, 2023, the entirety of which is hereby incorporated by reference.

### FIELD

The present disclosure is directed to the prediction of the remaining life (RL) of a bearing.

More particularly, the present disclosure deals with a method and a device for predicting the RL of a bearing.

### BACKGROUND

The RL of a bearing is defined as the remaining duration until the end of operation of the bearing, the end of operation of the bearing being defined as the appearance of a spall in a ring of the bearing or in a rolling element of the bearing.

It is known that bearing failures may lead to unplanned downtime with unforeseen costs, or even result in potential disasters.

To detect the failure of a bearing, the bearing is instrumented with at least one sensor for monitoring the bearing to detect a failure of the bearing, for example the appearance of a spall in one ring of the rings of the bearing or in a one rolling element of the bearing.

Generally, vibration sensors are used to monitor the condition of the bearing. The appearance of the spall is detected using spectrum analysis of vibration measurements.

However, when the appearance of the spall is detected, the bearing needs to be changed requiring to stop the machine incorporating the defaulting bearing resulting in loss of productivity.

Preventive maintenance operations may not be planned to prevent an unexpected stop of the machine.

Consequently, the present disclosure intends to predict the RL of a bearing specially to optimise the productivity of the machine incorporating the bearing.

### SUMMARY

According to an aspect, a method for predicting the remaining life of a bearing is proposed.

The method comprises:
measuring vibrations of the bearing, and
implementing a neural network configured to determine the remaining life of the bearing from the measured vibrations.

The device 9 gives a quantitative prediction of the remaining life for the bearing 4 from vibration measurements of the bearing 4.

The vibration measurements are inputted in the neural network without preprocessing so that the RL of the bearing is determined from raw vibration measurements.

The RL of the bearing is determined without knowledge of features of the bearing.

According to another aspect, a method for training a neural network configured to determine the remaining life of a bearing from measured vibrations is proposed.

The method comprises:
for at least a training bearing, obtaining at least one training set comprising vibration measurements of the training bearing and a measured remaining life of the training bearing associated to the vibration measurements,
implementing the neural network to determine a first output remaining life from the vibration measurements of the training set,
performing a first comparison between the measured remaining life of the training set and the first output remaining life, and
tuning weights of the neural network according to the result of the first comparison.

Advantageously, the method further comprises:
for at least one validation bearing, obtaining at least one validation set comprising vibration measurements of the validation bearing and a measured remaining life of the validation bearing associated to the vibration measurements,
implementing the neural network to determine a second output remaining life from the vibration measurements of the validation set,
performing a second comparison between the measured remaining life of the validation set and the second output remaining life,
wherein tuning weights of the neural network further comprises tuning weights of the neural network according to the result of the second comparison.

Preferably, each comparison between the said remaining life and the said output remaining life comprises determining the mean absolute error between the said remaining life and the said output remaining life.

According to another aspect, a device for predicting the remaining life of a bearing is proposed

The device comprises:
a memory storing a neural network configured to determine a remaining life of the bearing from measured vibrations of the bearing, and
implementing means configure to implement the neural network.

Preferably, the neural network comprises at least one stack of three layers, a dense layer and at least one recurrent layer comprising at least one recurrent unit, the stack of three layers comprising a convolutional layer, a batch normalisation layer and a max pooling layer.

Advantageously, the recurrent unit comprises a long short-term memory unit.

Preferably,
the implementing means are further configured to implement the neural network to determine a first output remaining life from vibration measurements of at least one training set, the training set comprising vibration measurements of a training bearing and a measured remaining life of the training bearing associated to the vibration measurements,
the device further comprising:
comparing means configured to perform a first comparison between the measured remaining life of the training set and the first output remaining life, and tuning means configured to tune weights of the neural network according to the result of the first comparison.

Advantageously:
the implementing means are further configured to implement the neural network to determine a second output remaining life from vibration measurements of at least one validation set, the validation set comprising vibration measurements of a validation bearing and a measured remaining life of the validation bearing associated to the vibration measurements,
the comparing means are further configured to perform a second comparison between the measured remaining life of the validation set and the second output remaining life, and
the tuning means are further configured to tune weights of the neural network according to the result of the second comparison.

According to another aspect, a bearing device is proposed.

The bearing device comprises a bearing, a sensor configured to measure vibrations of the bearing, and a device as defined above connected to the sensor.

### BRIEF DESCRIPTION OF THE DRAWINGS

Other advantages and features of the present disclosure will appear on examination of the detailed description of embodiments, in no way restrictive, and the appended drawings in which:

FIG. 1 illustrates schematically a rotating machine according to the present disclosure;

FIG. 2 illustrates schematically an example of a device for predicting the remaining life of a bearing according to the present disclosure;

FIG. 3 illustrates schematically an example of the architecture of a neural network according to the present disclosure, and

FIG. 4 illustrates an example of a method for training the neural network according to the present disclosure.

### DETAILED DESCRIPTION

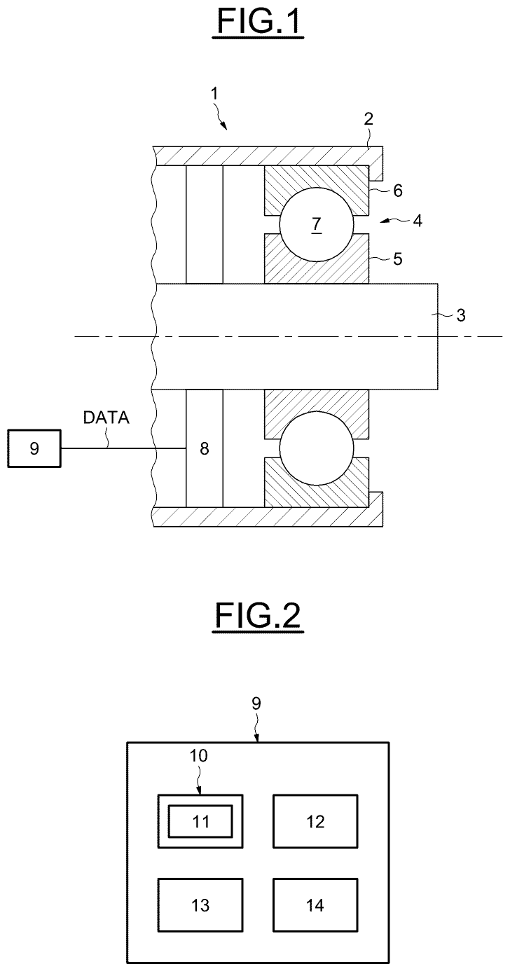

Reference is made to FIG. 1 which represents schematically a partial longitudinal cross section of a machine 1.

The machine 1 comprises a housing 2 and a shaft 3 supported in the housing 2 by a rolling bearing 4 (e.g. roller bearing or ball bearing).

The rolling bearing 4 is provided with a rotating ring 5 mounted on the shaft 3, and with a stationary ring 6 mounted into the bore of the housing 2. The stationary ring 6 radially surrounds the rotating ring 5. The rotating and stationary rings 5, 6 rotate concentrically relative to one another.

The rolling bearing 4 is further provided with a row of rolling elements 7 radially interposed between inner and outer raceways of the rotating and stationary rings 5, 6. In the illustrated example, the rolling elements 7 are balls. Alternatively, the rolling bearing may comprise other types of rolling elements 7, for example rollers. In the illustrated example, the rolling bearing comprise one row of rolling elements 7. Alternatively, the rolling bearing comprise may comprise several rows of rolling elements.

A sensor 8 is mounted in the housing 2 to measure vibrations of the bearing 4.

The sensor 8 may be mounted on a bore of the housing 2.

In variant, the sensor 8 may be mounted elsewhere on the machine, near the stationary ring 6 or in the vicinity of housing 2, for example.

The sensor 8 delivers a data item DATA representative of the vibrations of the bearing 4 to a device 9 for predicting the remaining life RL of the bearing 4.

The bearing 4, the sensor 8 and the device 9 form a bearing device.

FIG. 2 illustrates schematically an example of the device 9.

The device 9 comprises a memory 10 storing a neural network 11 processing the data item DATA delivered by the sensor 8, implementing means 12, tuning means 13 and comparing means 14.

The implementing means 12 comprise for example a processing unit implementing the neural network 11, the implementing means 12, the tuning means 13 and the comparing means 14.

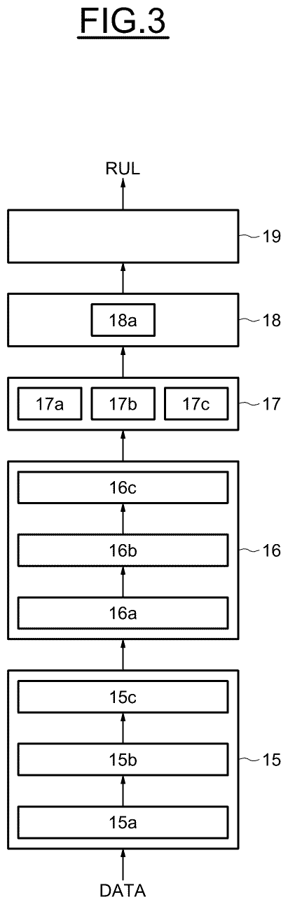

FIG. 3 illustrates schematically an example of the architecture of the neural network 11.

The neural network 11 may be a hybrid Convolutional Neural Network CNN/Recurrent Neural Network RNN.

The neural network 11 comprises for example a first stack 15 of three layers, a second stack 16 of three layers, a first recurrent layer 17, a second recurrent layer 18 and a dense layer 19 successively processing the data item DATA to determine the RL of the bearing 4.

Each stack 15, 16 of three layers comprises a convolutional layer 15a, 16a, a batch normalisation layer 15b, 16b and a max pooling layer 15c, 16c successively processing data item.

The stacks 15, 16 extract features from the data item DATA and reduce the size of the input signal of the first recurrent layer 17.

This reduction of size is a crucial step that needs to be done to train the neural network 11 using reasonable resources in a reasonable amount of time.

The rectified linear unit ReLu activation function may be used for the convolutions. Batch normalisation operations are applied after each convolution before applying the activation function.

The first recurrent layer 17 comprises for example three recurrent units 17a, 17b, 17c and the second recurrent layer 18 comprises for example one recurrent unit 18a.

Each recurrent unit 17a, 17b, 17c, 18a comprises for example a long short-term memory LSTM unit.

The first and second recurrent layers 17, 18 are intended to capture the chronological dependence of data item DATA.

The dense layer 19 comprise a ReLu giving the prediction of the RL until the failure of the bearing 4.

Implementing a ReLu in the dense layer 19 allows the neural network 11 to deliver any positive real number of the RL of the bearing 4.

Note that neural network 11 is trained to minimise at least one cost function relating to, for example, mean square error, mean absolute error or binary cross entropy.

The trained neural network 11 implemented by the implementing means 12 determines the remaining life RL of the bearing 4 from the measured vibrations in the data item DATA delivered by the sensor 8.

The number of stacks of three layers, the number of recurrent layers and the number of recurrent units in each recurrent layer are determined according to the expected accuracy of the URL delivered by the neural network 11.

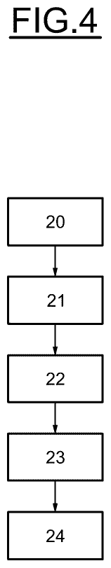

FIG. 4 illustrates an example of a method for training the neural network 11.

In a step 20, training sets are obtained.

Each training test is obtained from a training bearing, and comprises vibration measurements of the training bearing and a measured remaining life of the training bearing associated to the vibration measurements

For each training set, a training bearing is tested for example on a test bench. Vibration measurements are collected using accelerometers located on the bearing 4 according to the time.

The vibration measurements are process using spectrum analysis of vibration measurements to determine the appearance of a spall, the instant of appearance of the spall being recorded.

The remaining life RL is equal to the difference between the instant of the start of recording the vibrations and the instant of appearance of the spall.

The appearance of the spall may further be certified by eyes control.

In a step 21, the neural network 11 is trained from the training sets.

For each training set, the implementing means 12 implement the neural network 11 to determine a first output remaining life from the vibration measurements of the said training set.

In a step 22, for each training set, the comparing means 14 perform a first comparison between the measured remaining life of the said training set and the first output remaining life determined by the neural network 11 from the vibration measurements of the said training set.

The comparing means 14 may implement a mean absolute error algorithm.

The tuning means 13 tune weights of the neural network 11 according to the result of the first comparison to minimise the cost function related to for example mean absolute error.

The method may further comprise validation steps 23, 24, 25 of the trained neural network 11 to check that the accuracy of the RL determined by the neural network 11 is enough.

It is assumed that validation sets are obtained.

Each validation set comprises vibration measurements of a validation bearing and a measured remaining life of the validation bearing associated to the vibration measurements.

The validation sets may be obtained in the same way as the training sets described in step 20.

In a step 23, for each validation step, the implementing means 12 implement the neural network 11 to determine a second output remaining life from the vibration measurements of the said validation set.

In a step 24, for each training set, the comparing means 14 perform a second comparison between the measured remaining life of the said validation set and the second output remaining life determined by the neural network 11 from the vibration measurements of the said validation set.

The tuning means 13 tune weights of the neural network 11 according to the result of the second comparison to minimise the cost function.

The device 9 gives a quantitative prediction of the remaining life for the bearing 4 from vibration measurements of the bearing 4.

What is claimed is:

1. A method for predicting the remaining life of a bearing, the method comprising:
measuring vibrations of the bearing, and
implementing a neural network configured to determine the remaining life of the bearing from the measured vibrations.

2. A method for training a neural network configured to determine the remaining life of a bearing from measured vibrations, the method comprising:
for at least a training bearing, obtaining at least one training set comprising vibration measurements of the training bearing and a measured remaining life of the training bearing associated to the vibration measurements,
implementing the neural network to determine a first output remaining life from the vibration measurements of the training set,
performing a first comparison between the measured remaining life of the training set and the first output remaining life, and
tuning weights of the neural network according to the result of the first comparison.

3. The method according to claim 2, further comprising:
for at least one validation bearing, obtaining at least one validation set comprising vibration measurements of the validation bearing and a measured remaining life of the validation bearing associated to the vibration measurements,
implementing the neural network to determine a second output remaining life from the vibration measurements of the validation set,
performing a second comparison between the measured remaining life of the validation set and the second output remaining life,
wherein tuning weights of the neural network further comprises tuning weights of the neural network according to the result of the second comparison.

4. A method according to claim 2, wherein each comparison between the said remaining life and the said output remaining life comprises determining the mean absolute error between the said remaining life and the said output remaining life.

5. A method according to claim 3, wherein each comparison between the said remaining life and the said output remaining life comprises determining the mean absolute error between the said remaining life and the said output remaining life.

6. The device for predicting the remaining life of a bearing, the device comprising:
a memory storing a neural network configured to determine a remaining life of the bearing from measured vibrations of the bearing, and
implementing means configure to implement the neural network.

7. The device according to claim 6, wherein the neural network comprises at least one stack of three layers, a dense layer and at least one recurrent layer comprising at least one recurrent unit, the stack of three layers comprising a convolutional layer, a batch normalisation layer and a max pooling layer.

8. The device according to claim 7, where the recurrent unit comprises a long short-term memory unit.

9. The device according to claim 6, wherein:
the implementing means is configured to implement the neural network to determine a first output remaining life from vibration measurements of at least one training set, the training set comprising vibration measurements of a training bearing and a measured remaining life of the training bearing associated to the vibration measurements,
the device further comprises:
comparing means configured to perform a first comparison between the measured remaining life of the training set and the first output remaining life, and
tuning means configured to tune weights of the neural network according to the result of the first comparison.

10. The device according to claim 9, wherein:
the implementing means is configured to implement the neural network to determine a second output remaining life from vibration measurements of at least one validation set, the validation set comprising vibration measurements of a validation bearing and a measured remaining life of the validation bearing associated to the vibration measurements,
the comparing means is configured to perform a second comparison between the measured remaining life of the validation set and the second output remaining life, and
the tuning means is configured to tune weights of the neural network according to the result of the second comparison.

11. The device according to claim 8, wherein:
the implementing means is configured to implement the neural network to determine a first output remaining life from vibration measurements of at least one training set, the training set comprising vibration measurements of a training bearing and a measured remaining life of the training bearing associated to the vibration measurements,
the device further comprises:
comparing means configured to perform a first comparison between the measured remaining life of the training set and the first output remaining life, and
tuning means configured to tune weights of the neural network according to the result of the first comparison.

12. The device according to claim 11, wherein:
the implementing means is configured to implement the neural network to determine a second output remaining life from vibration measurements of at least one validation set, the validation set comprising vibration measurements of a validation bearing and a measured remaining life of the validation bearing associated to the vibration measurements,
the comparing means is configured to perform a second comparison between the measured remaining life of the validation set and the second output remaining life, and
the tuning means is configured to tune weights of the neural network according to the result of the second comparison.

13. A bearing device comprising:
a bearing,
a sensor configured to measure vibrations of the bearing, and
a device according to claim 5 connected to the sensor.

14. A bearing device comprising:
a bearing,
a sensor configured to measure vibrations of the bearing, and
a device according to claim 12 connected to the sensor.
